(19) United States
(12) Patent Application Publication
(10) Pub. No.: US 2023/0268508 A1
(43) Pub. Date: Aug. 24, 2023

(54) ANODE-FREE METAL HALIDE BATTERY

(71) Applicant: International Business Machines Corporation, Armonk, NY (US)

(72) Inventors: Yumi Kim, San Jose, CA (US); Anthony Bock Fong, San Jose, CA (US); YOUNG-HYE Na, San Jose, CA (US)

(21) Appl. No.: 17/651,823

(22) Filed: Feb. 21, 2022

(51) Int. Cl. H01M 4/62; H01M 10/0525

(52) U.S. Cl. CPC H01M 4/62; H01M 4/625; H01M 10/0525; H01M 2004/021

(57) ABSTRACT

Provided is an anode-free metal halide battery. The metal halide battery comprises a current collector, an electrolyte, and a cathode. The current collector comprises a passivation layer of an electrically insulating material. The passivation layer allows metal ion transport. The electrolyte comprises an ion-conducting material and is in contact with the current collector and the cathode. The cathode comprises a metal halide salt incorporated into an electrically conductive metal.

### BACKGROUND

The present disclosure relates generally to the field of rechargeable batteries, and more particularly to anode-free metal halide rechargeable batteries.

Rechargeable batteries are used as a power source in a wide range of applications such as, for example, industrial devices, medical devices, electronic devices, electric vehicles, and grid energy storage systems. Battery technology is continually being developed to enable higher energy density and greater efficiency, which makes it possible to use batteries as power sources for additional applications.

### SUMMARY

Embodiments of the present disclosure include an anode-free metal halide battery. The metal halide battery comprises a current collector, an electrolyte, and a cathode. The current collector comprises a passivation layer of an electrically insulating material. The passivation layer allows metal ion transport. The electrolyte comprises a solvent and at least one ion conducting salt and is in contact with the current collector and the cathode. The cathode comprises a metal halide salt incorporated into an electrically conductive material. This anode-free metal halide battery may have several advantages over alternative designs. For example, when compared to current lithium-ion batteries that use graphite anodes, the disclosed anode-free metal halide battery has higher energy density thanks to lithium’s gravimetric and volumetric advantages when compared to graphite. Additionally, these anode-free metal halide batteries can be easier to manufacture than solutions that use a lithium metal anode, which requires more advanced manufacturing facilities to handle lithium metal’s air and moisture sensitivity.

In some optional embodiments, the passivation layer includes an artificially formed ion-conducting material. The ion-conducting material may comprise, for example, polyvinyl alcohol (PVA) and/or polyethylene glycol (PEG). The inclusion of the ion-conducting passivation layer can improve the coulombic efficiency of the batteries. Additionally, the ion-conducting passivation layer creates more stable battery performance across cycles, with increased consistency of the capacity retention during battery cycling.

Additional embodiments are directed at another anode-free metal halide battery. The metal halide battery comprises a current collector, an electrolyte, and a cathode. The electrolyte comprises a solid-state ion conductor and is in contact with the current collector and the cathode. The cathode comprises a metal halide salt incorporated into an electrically conductive material.

Further embodiments of the present disclosure include a method for forming an anode-free metal halide battery. The method comprises forming a metal halide battery cell. The metal halide battery cell includes an anode-current collector and does not include a discrete metallic anode. The method further comprises applying a charging voltage to the halide battery cell to cause metal ions to deposit on the anode-current collector.

The above summary is not intended to describe each illustrated embodiment or every implementation of the present disclosure.

### BRIEF DESCRIPTION OF THE DRAWINGS

The drawings included in the present disclosure are incorporated into, and form part of, the specification. They illustrate embodiments of the present disclosure and, along with the description, serve to explain the principles of the disclosure. The drawings are only illustrative of typical embodiments and do not limit the disclosure.

FIG. 1 illustrates a diagram of an example anode-free metal halide battery prior to initial charging, in accordance with embodiments of the present disclosure.

FIG. 2 illustrates a diagram of the example anode-free metal halide battery of FIG. 1 after the initial charging, in accordance with embodiments of the present disclosure.

FIG. 3 illustrates a diagram of the example anode-free metal halide battery of FIG. 2 within an enclosed cell, in accordance with embodiments of the present disclosure.

FIG. 4 depicts scanning electron microscope (SEM) images of a conventional lithium-ion anode-current collector and a metal halide anode-current collector constructed in accordance with embodiments of the present disclosure.

FIG. 5 is a graph illustrating initial charge and discharge curves for anode-free battery cells comprising a lithium-ion intercalation cathode (solid lines) and a metal halide cathode (dotted lines) constructed in accordance with embodiments of the present disclosure.

FIG. 6 is a graph illustrating charge and discharge curves for two different anode-free metal halide battery cells assembled with a bare SS current collector (open squares) and a polymer-coated SS current collector (solid squares), in accordance with embodiments of the present disclosure.

FIG. 7 is a graph illustrating cycle performance data for two different anode-free metal halide battery cells assembled with a bare SS current collector (open circles) and a polymer-coated SS current collector (solid circles), in accordance with embodiments of the present disclosure.

FIG. 8A depicts cross-sectional SEM images of a polymer-coated current collector of an anode-free lithium iodide battery after lithium deposition by initial charging, in accordance with embodiments of the present disclosure.

FIG. 8B is a magnified portion of the SEM image of FIG. 8A illustrating round-shaped lithium deposits on the current collector, in accordance with embodiments of the present disclosure.

FIG. 9 is a graph illustrating charge and discharge curves for an anode-free metal halide battery having a Ni current collector, in accordance with embodiments of the present disclosure.

FIG. 10 is a graph illustrating cycle performance data for anode-free lithium iodide battery cells assembled with four different anode-current collectors, in accordance with embodiments of the present disclosure.

FIG. 11 illustrates a flowchart of an example method for forming an anode-free metal halide cathode battery cell, in accordance with embodiments of the present disclosure.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the invention.

### DETAILED DESCRIPTION

Aspects of the present disclosure relate generally to the field of rechargeable batteries, and more particularly to anode-free metal halide rechargeable batteries. While the present disclosure is not necessarily limited to such applications, various aspects of the disclosure may be appreciated through a discussion of various examples using this context.

Lithium-ion batteries are used in many applications, such as for powering small power tool, electric vehicles, and for storing energy for energy grid systems. As more applications for energy storage are developed, the demand for higher energy density batteries continues to increase, and intensive research and development from industry and academia has been conducted to satisfy the ever increasing requirements in terms of energy density and battery safety.

Current lithium-ion batteries based on the graphite anode have intrinsic capacity limitations which restrict the overall energy density of the battery. To overcome these limitations, the most common approaches being actively researched are lithium metal-based batteries since lithium metal has gravimetric and volumetric advantages when it is applied as an anode. The main challenge to increasing the energy density of such batteries is in making a thinner lithium anode to reduce the extra lithium source and increase the volumetric energy density. However, due to the lithium metal being intrinsically reactive to the electrolyte compounds and the uneven plating of lithium ions by nature, the transition to the practical Li metal-based batteries is not easy. Another approach is to replace the traditional graphite anode with a soft lithium metal anode, but this would require advanced manufacturing facilities with improved environmental control as the lithium metal is air and moisture sensitive. Lithium metal’s softness would also create significant challenges in handling and manufacturing.

Recently, a team at IBM-Research demonstrated high performance rechargeable metal halide batteries using lithium metal anodes. Those inventions reported that the metal halide battery has the formation of a stable anode protection layer, which can help to enhance the fast-charging performance and long-term battery operation. In order to further improve gravimetric and volumetric energy densities of this metal halide battery, while eliminating the concerns associated with sensitive metallic anode described above, disclosed herein is a new type of rechargeable metal halide battery that does not use a discrete metallic anode. This anode-free metal halide battery can reduce the side reactions from the highly reactive lithium metal and give a uniform lithium-ion plating at cycles. Additionally, the disclosed anode-free metal halide battery can have a higher energy density than conventional batteries.

Embodiments of the present disclosure are directed to a new type of rechargeable metal halide battery. In particular, some embodiments of the present disclosure comprise a conductive current collector in the negative electrode, an electrolyte, and a cathode. The cathode comprises a metal halide and an electrically conducting material.

Unlike conventional batteries, the disclosed batteries don’t require any metallic anode in the initial cell assembly. Instead, the metal halide cathode includes metal-ions that can be deposited on a conductive current collector in the negative electrode at the first charging step. These deposited metals then act as the anode active material, participating in the sequential electrochemical reactions upon cycling. By using the unique surface protecting species of metal halide battery system, uniform metal-ion plating and stripping is available even on the current collector, and this enables stable operation of the battery. Additionally, because embodiments of the present disclosure do not use sensitive metallic anode (e.g., lithium foils), the cell manufacturing process can be much simpler without any concerns associated with handling soft metal foils (e.g., dent, crease, etc.) and controlling unwanted side reactions of the metals. Furthermore, the anode-free metal halide batteries disclosed herein may suppress lithium dendrite formation, thereby preventing short-circuits while retaining improved energy density of the battery cells.

It is to be understood that the aforementioned advantages are example advantages and should not be construed as limiting. Embodiments of the present disclosure can contain all, some, or none of the aforementioned advantages while remaining within the spirit and scope of the present disclosure.

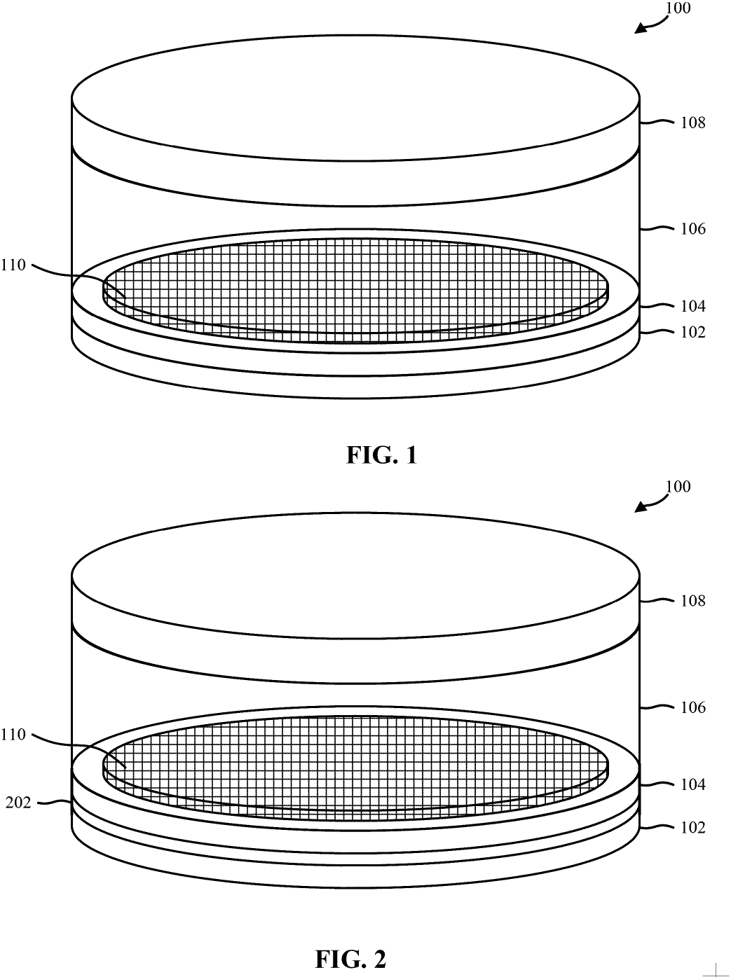

Turning now to the figures, FIG. 1 illustrates a diagram of an example anode-free metal halide battery 100 prior to initial charging, in accordance with embodiments of the present disclosure. As used herein, “anode-free” means that the battery 100 in its initial configuration (i.e., prior to initial or first charging) does not contain a lithium anode. The battery 100 includes a current collector 102, a protective coating 104 formed on top of the current collector 102, and electrolyte 106, and a cathode 108. Additionally, the battery 100 includes a separator 110. In some embodiments, the battery 100 may not include the separator 110 and/or the protective coating 104, as discussed herein. The battery 100 operates via reduction-oxidation (redox) reactions and utilizes different oxidation states and redox reactions of one or more components or elements for charge and discharge. It is to be understood that the figures are not necessarily drawn to scale in order to make it easier to visualize each component separately. For example, the protective coating 104 may be substantially thinner than depicted in the figures.

In some embodiments, the current collector 102 is a metal, and suitable examples include, but are not limited to, stainless steel, nickel, and mixtures and combinations thereof. In the present application, a component consisting of a particular material may in some cases include incidental impurities.

In some embodiments, the protective coating 104 is any suitable coating that is conductive to lithium ions. In other words, the protective coating 104 allows lithium ions to pass through it. The protective coating can be a naturally formed passivation layer called a solid-electrolyte interphase layer (SEI) or a polymer coating (artificial SEI) that is artificially applied onto the current collector 102. Example polymers that may be used include, but are not limited to, polyvinyl alcohol (PVA), poly(ethylene glycol), poly(propylene glycol), polycarbonates, polyesters, polyethylene oxide (PEO), polyurethane (PU), styrene-butadiene rubber (SBR), polyvinylidene difluoride (PVDF), poly(tetrafluoroethylene) (PTFE), and a combination of poly(ethylene glycol) (PEG) copolymerized with polyhedral oligomeric silsesquioxane (POSS), also referred to as PEG-POSS. Protective coating 104 can be a single ion conductor or a polyelectrolyte which includes a polymer with a sulfonic acid group, a carboxylic acid group, and a phosphonic acid group or any strong acid group attached to the polymer matrix in lithium salt form. In some embodiments, the protective coating 104 can comprises inorganic metal oxides and/or metal sulfides. In some embodiments, the protective coating 104 thickness is approximately 20 µm, and the coating layer comprises a UV-crosslinked polymer. In some embodiments, the protective coating 104 is electrically insulating, in addition to having lithium ion conductivity. This helps prevent electrons from flowing in the electrolyte 106 while still allowing the lithium ions to pass through and deposit on the current collector 102.

The electrolyte 106, which may be aqueous or non-aqueous, includes a solvent and at least one ion conducting salt that dissociates into a respective metal ion and a respective counter anion. In some examples, which are not intended to be limiting, the metal ion includes at least one of Li, Mg, Zn, Al and Na, and the counter anion includes one or more of nitrate (NO₃⁻), hexafluorophosphate (PF₆⁻), tetrafluoroborate (BF₄⁻), bisoxalato borate(BOB⁻), difluorooxalato borate (DFOB⁻), trifluoromethanesulfonate (TF⁻), and trifluorosulfonylimide (TFSI⁻).

In some embodiments, the electrolyte 106 is a solid-state electrolyte comprising ion-conducting materials. The electrolyte 106 may further be electrically isolating. For example, the electrolyte 106 may be a solid polymer electrolyte (SPE), an inorganic solid electrolyte (ISE, such as a ceramic), or a composite polymer electrolyte (CPE). In some embodiments, the ion-conducting protective coating 104, which may be a polymer, can act as the solid-state electrolyte.

In some embodiments, the electrolyte 106 also includes an optional metal halide (e.g., MXn, where M is a metal, X is a halogen, and n is an integer greater than 0). In some examples, the metal halide is an electrolyte salt that dissociates into a respective halide ion and a respective metal ion. For example, the metal halide may dissolve in the solvent including the heterocyclic compound and dissociate into the respective metal and halide ions. In some examples, the halide ion may include an ion of at least one of I, Br, Cl, or F (e.g., X may be I, Br, Cl, or F), and the metal ion may include an ion of at least one of Li, Mg, Zn, Al or Na (e.g., M may be Li, Mg, Zn, Al or Na). In other examples, the metal halide may include elements other than I, Br, Cl, F, Li, Mg, Zn and/or Na. In some embodiments, the metal halide may provide the electrolyte 106 with additional ionic conductivity.

In various embodiments, the electrolyte 106 includes one or more solvents capable of transporting the metal ions and counter ions. In various embodiments, which are not intended to be limiting, suitable solvents may be chosen from non-aqueous, organic solvents such as an ether, a glyme, a carbonate, a nitrile, an amide, an amine, an organosulfur solvent, an organophosphorus solvent, an organosilicon solvent, a fluorinated solvent, adiponitrile (ADN), propylene carbonate (PC), dimethoxyethane (DME), and mixtures and combinations thereof.

In some examples, one or more additional solvents may be included in the electrolyte 106 to further improve the electrochemical performance of battery 100, such as, for example, by enhancing rechargeability, cyclability, or the like.

In some embodiments, which are not intended to be limiting, the solvent in the electrolyte 106 includes an optional heterocyclic compound, which in this application refers to an aromatic or non-aromatic cyclic compound having as ring members atoms of at least two different elements. A cyclic compound (ring compound) as used in the present application refers to a compound in which one or more series of atoms in the compound is connected to form a ring. In various embodiments, suitable cyclic compounds for the electrolyte 106 include 5-membered rings such as pyrrolidines, oxolanes, thiolanes, pyrroles, furans and thiophenes; 6-membered rings such as piperadines, oxanes, thianes, pyridines, pyrans and thiopyrans; and 7-membered rings such as azepanes, oxepanes, thiepanes, azepines, oxepines, and thiepenes. Examples of suitable heterocyclic compounds include, but are not limited to, tetrahydrofuran, tetrahydropyran, tetrahydrothiophene, oxathiolane, succinimide, oxazolidone, _{γ}-butyrolactone, γcaprolactone, ε-caprolactone, γ-valerolactone, pyrrolidine, imidazolidine, sulfolane, thiane, dioxolane, and mixtures and combinations thereof. In some embodiments, suitable heterocyclic compounds include, but are not limited to, cyclic ethers, cyclic esters, and mixtures and combinations thereof.

In some examples, the electrolyte 106 includes substantially equal parts of the solvent including the heterocyclic compound and the one or more additional solvents.

In another embodiment, which is not intended to be limiting, the solvent in the electrolyte 106 includes an optional nitrile compound. The nitrile compound has the chemical formula of N═C—R or N═C—R—C═N, where R is an organic functional group. Examples of organic functional groups for the nitrile compound include ethers, alkyls ethers, thioethers, alkyl thioethers, or the like. In some examples, which are not intended to be limiting, the nitrile compound is chosen from valeronitrile, nonanenitrile, hexanenitrile, acetonitrile, propionitrile, glutaronitrile, methoxyacetonitrile (MAN), methoxybenzonitrile, methoxypropionitrile (e.g., 3-methoxypropionitrile (MPN)), methylglutaronitrile, butoxypropionitrile, butoxybenzonitrile, and mixtures and combinations thereof. In some examples, the nitrile compound in the electrolyte 106 may improve electrochemical performance (e.g., reversibility, rechargeability, and/or cyclability), produce fewer irreversible carbonate byproducts, or improve power density.

In some examples, the electrolyte 106 includes equal parts of the solvent including the nitrile compound and the one or more additional solvents.

The electrolyte 106 includes an oxidizing gas. In some examples, electrolyte 106 may be in the presence of an oxidizing gas, and the phrase “includes an oxidizing gas” is intended to include such a configuration. In some examples, the oxidizing gas may be dissolved in the solvent including the electrolyte 106. In some examples, which are not intended to be limiting, the oxidizing gas includes at least one of oxygen, air, nitric oxide, or nitrogen dioxide. The oxidizing gas helps induce the redox reactions of battery 100 as described above, and helps achieve highly reversible redox reactions, which may contribute to enhanced electrochemical performance of battery 100. The oxidizing gas may help induce such redox reactions and contribute to the consolidation and stabilization of a solid-electrolyte interphase (SEI) layer on the electrodes (i.e., the current collector 102 and the cathode 108), but does not participate in the capacity-generating redox reactions of battery 100. In some examples, an electrolyte lacking the oxidizing gas may exhibit little or no rechargeability.

In the embodiments discussed below with respect to the experimental results and examples, the electrolyte 106 is a mixture of approximately 0.2 M LiNO₃ and approximately 0.5 M LiTFSI (Lithium bis(trifluoromethanesulfonyl)imide) in dioxolane (DOL), with 1,2-dimethoxyethane (DME) also being included.

The cathode 108 releases electrons by a redox reaction of metal halides during charge of the battery 100 and provides a conductive path to an external electrical circuit to which the battery 100 is connected while metal ions diffuse from the cathode toward the current collector through electrolyte 106 and reduce to metal on the current collector in the negative electrode by receiving the electron transported from the external circuit. Similarly, during discharge of the battery 100, the deposited lithium metal oxidizes to lithium ions, releasing electrons through an external electrical circuit to which the battery 100 is connected, and the cathode redox reaction occurs on the cathode 108 by receiving the electrons transferred from the external electrical circuit.

The cathode 108 includes an electrically conductive material and a metal halide salt incorporated into or applied on the electrically conductive material. In various embodiments, the total amount of metal halide in the cathode 108 is greater than the amount of metal halide in the electrolyte 106, or at least twice the total amount of the metal halide in the electrolyte 106, or 3 times the amount, or 5 times the amount.

In some examples, which are not intended to be limiting, the electrically conductive material in the cathode 108 may include an electrically conductive powder independently selected from metal and/or carbon powders, woven or non-woven metal fibers, metal foam, woven or non-woven carbon fibers, or the like. Additionally, or alternatively, the cathode 108 may include stainless-steel mesh, aluminum (Al) mesh, nickel (Ni) foam, carbon cloth and/or carbon paper. For example, in one embodiment, the cathode 108 may include a stainless-steel mesh with carbon nanoparticles deposited thereon.

In another embodiment, the cathode 108 may be a porous material that is electrically conductive. In some embodiments, the cathode 108 can include carbon materials selected from an amorphous carbon material, a crystalline carbon material, and mixtures and combinations thereof. Suitable amorphous carbon materials include, but are not limited to, particles of carbon black and porous glassy carbon, and mixtures and combinations thereof. In some embodiments, the crystalline carbon material includes, but is not limited to, graphene, graphene oxide, reduced graphene oxide, carbon nanotubes, and mixtures and combinations thereof.

In some embodiments, the cathode 108 may include an optional powder of a material such as, for example, lithium cobalt oxide (LCO, e.g., LiCoO₂), lithium-nickel-cobalt-aluminum oxide (NCA, e.g., LiNiₓCo_{y}Al_{Z}O₂, LiNi_{0.8}Co_{0.15}Al_{0.05}O₂), lithium ion manganese oxide (LMO, e.g., LiMn₂O₄), lithium nickel manganese cobalt oxide (NMC, e.g., LiNiMnCoO₂), nickel cobalt manganese (NCM, e.g., LiNiₓCo_{y}Mn_{z}O₂, LiNi_{0.33}Co_{0.33}Mn_{0.33}O₂) or lithium iron phosphate (LFP, e.g., LiFePO₄), and mixtures and combinations thereof.

The cathode 108 includes at least one metal halide salt MXn, where M is a metal, X is a halide, and n is an integer greater than 0 (e.g., 1 - 3). In some examples, the metal halide includes an ion of at least one of I⁻, Br⁻, Cl⁻, or F⁻ (e.g., X may be I, Br, Cl, or F), and the metal ion may include an ion of at least one of Li⁺, Mg²⁺, Zn²⁺, Al³⁺, or Na⁺ (e.g., M may be Li, Mg, Zn, Al or Na). In other examples, the metal halide may include elements other than I, Br, Cl, F, Li, Mg, Zn, Al and/or Na.

In some embodiments, the cathode 108 may optionally include a polymeric binder. Suitable polymeric binders may vary widely, and examples include, but are not limited to, poly(tetrafluoroethylene)(PTFE), polyvinylidene fluoride (PVDF) or sulfonated tetrafluoroethylene based fluoropolymer-copolymers available from DowDuPont, Midland, MI, under the trade designation NAFION, and mixtures and combinations thereof.

In some embodiments, the cathode optionally includes a halogen diatomic molecule. Suitable halogen diatomic molecules include I₂, Br₂, Cl₂, and F₂.

In various embodiments, the cathode 108 includes about 25 wt% of the electrically conductive material, about 70 wt% of the metal halide salt, and about 5 wt% of the optional polymeric binder, based on the total weight of the cathode 108. For example, in some embodiments, the cathode 108 includes about 50 wt% to about 80 wt% of the metal halide, or about 40 wt% to about 90 wt%, or about 30 wt% to about 100 wt%, or about 10 wt% to about 100 wt%, based on the total weight of the cathode 108.

In various embodiments, the metal halide in the cathode 108 may be interspersed or distributed throughout a matrix of the electrically conductive material and any polymeric binder present. In some embodiments, the electrically conductive material itself may be a porous material, and the metal halide salt may be located in a plurality of the pores therein. In some embodiments, the metal halide may also be adsorbed into the electrically conductive material and/or the polymeric binder, in addition to being located in the pores. In some embodiments, the metal halide salt forms a gradient in the electrically conductive matrix material or may be concentrated near a major surface of the cathode to form on or more metal halide rich layers.

In the embodiments discussed below with respect to the experimental results and examples, the cathode 108 includes lithium-iodide deposited on to a porous carbon cathode (LiI-carbon composite cathode). The porous carbon cathode includes an activated carbon (hosting material), super-P (electron conducting agent), and styrene butadiene rubber/carboxymethyl cellulose (SBR/CMC) binders, which were prepared by coating a slurry of carbons/binder mixture in an alcohol with 85/15 weight ratio on a stainless steel current collector. The active cathode material, LiI in methanol, is separately formulated and dosed onto the carbon cathode to form the LiI-carbon composite cathode. The LiI-carbon composite cathode was then dried on the 120° C. hotplate for approximately 12 hours, and all dosing and drying processes were conducted in an Ar-filled glove box.

In some examples, the battery 100 includes an optional separator 110. The separator 110 forces electrons through an external electrical circuit to which the battery 100 is connected such that the electrons do not travel through the battery 100 (e.g., through the electrolyte 106 of the battery 100), while still enabling the metal ions to flow through the electrolyte 106 of the battery 100 during charge and discharge. In some examples, the separator 110 may be soaked with the electrolyte 106, within the electrolyte 106, surrounded by the electrolyte 106, or the like. The separator 110 may include an electrically non-conductive material to prevent movement of electrons through the battery 100 such that the electrons move through the external circuit through the battery terminals instead. For example, the separator 110 may include glass, non-woven fibers, polymer films, rubber, or the like. In the embodiments discussed below with respect to the experimental results and examples, the separator 110 is a Celgard® 2325 separator placed between the cathode and the anode.

In some examples, the battery 100 has a closed or substantially closed volume. For example, current collector 102, protective coating 104, electrolyte 106, cathode 108, and separator 110 may be within a closed or substantially closed cell or other enclosure. In this way, the oxidizing gas of the electrolyte 106 remains within the battery 100 such that the battery 100 has a relatively fast charging rate, high energy efficiency, high power density, high reversibility, high cyclability, and/or combinations thereof, as described herein.

Referring now to FIG. 2, illustrated is a diagram of the example anode-free metal halide battery 100 of FIG. 1 after the initial charging, in accordance with embodiments of the present disclosure. As shown in FIG. 2, the battery 100 is substantially identical to what was shown in FIG. 1 except that the initial charging of the battery 100 caused lithium ions to be reduced to metallic lithium 202 plating on the current collector 102. In other words, charging of the battery 100 caused lithium ions that were initially present in the cathode 108 to move through the electrolyte 106 and permeate the protective coating 104 before plating on top of the current collector 102 in the form of metallic lithium 202 by receiving electrons transferred through the external circuit and the current collector. The metallic lithium 202 may effectively act as an anode for the battery 100 during subsequent operations. In other words, the metallic 202 may take up metal ions from the electrolyte 106 during charging and release the metal ions to the electrolyte 106 during discharging. In this way, the battery 100 may be fabricated without a discrete anode (e.g., without a lithium foil anode), and the anode may subsequently be formed through deposition of lithium 202 on the current collector 102 during initial charging.

The battery 100 may be capable of undergoing many charging and discharging cycles (e.g., exhibits good rechargeability), even at relatively high charging current densities. In some examples, the battery 100 is capable of completing at least 100 cycles of charging and discharging at a current density of greater than or equal to about 1 mA/cm², about 5 mA/cm², about 10 mA/cm², or about 20 mA/cm². As one example, battery 100 may be capable of completing at least 1000 cycles of charging and discharging at a current density of greater than or equal to about 1 mA/cm², about 5 mA/cm², about 10 mA/cm², or about 20 mA/cm².

Additionally, or alternatively, the battery 100 may exhibit a relatively high energy efficiency. For example, the battery 100 may exhibit an energy efficiency of greater than or equal to 90% at a current density of greater than or equal to about 1 mA/cm², about 5 mA/cm², about 10 mA/cm², or about 20 mA/cm². In some examples, the battery 100 may exhibit an energy efficiency of greater than or equal to 99% at a current density of greater than or equal to about 1 mA/cm², about 5 mA/cm², about 10 mA/cm², or about 20 mA/cm².

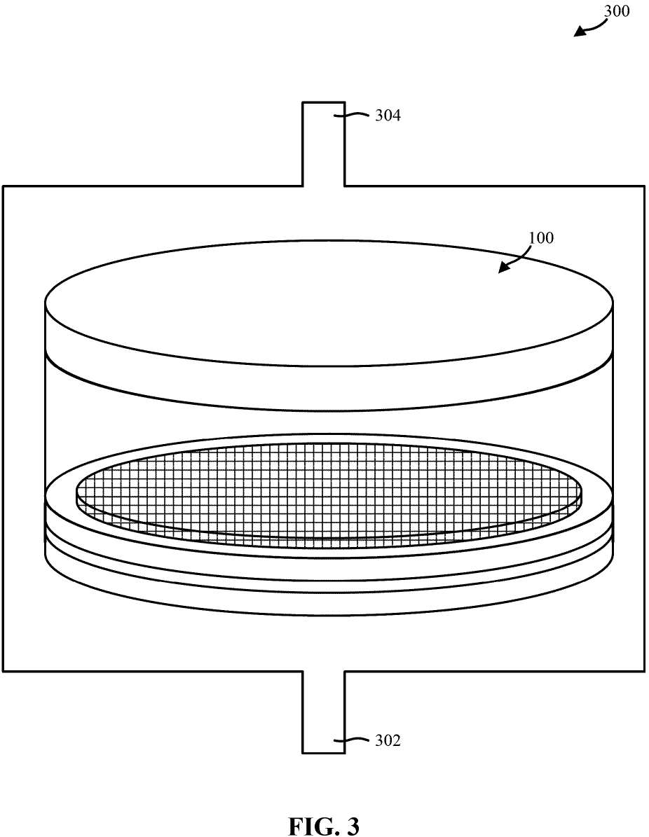

Referring now to FIG. 3, illustrated is a diagram of the example anode-free metal halide battery 100 of FIG. 2 within an enclosed cell 300, in accordance with embodiments of the present disclosure. The enclosed cell 300 may include a cell that houses the battery 100 during operation of the battery 100, a cell used to fabricate the battery 100, or both. For example, the enclosed cell 300 may include a cell available from Swagelok of Solon, OH, under the trade designation SWAGELOK, and may be used to fabricate the battery 100. In some examples, the enclosed cell 300 may include an inlet tube 302 and/or an outlet tube 304. The inlet tube 302 and outlet tube 304 may be used to introduce and remove air or other gases, such as the oxidizing gas of the electrolyte 106, into and out of the enclosed cell.

In one example embodiment, to fabricate the cathode 108, powders of the electrically conductive material, the metal halide, the lithium ions, and any optional polymeric binders are simply mixed together to form a slurry. In some embodiments, an optional solvent may be used to adequately disperse the powders. The slurry is then cast on a surface of the separator 110 or any type of mesh, which may be referred to herein as a gas diffusion layer (GDL), and dried to form the cathode 108. In another embodiment, the slurry is cast on a surface of an optional current collector (ex. metal foil) in the positive electrode. In various non-limiting embodiments, the slurry may be air-dried, dried in an oven, or a combination thereof.

In some examples, the metal halide may itself be dried prior to being incorporated into the slurry. In one non-limiting example, the metal halide may be dried on a hotplate in an argon filled glovebox at about 120° C. for greater than 12 hours.

To make a battery cell, the current collector 102 and the optional separator 110 with the cathode 108 formed thereon may be stacked together. In some embodiments, the optional separator 110 is soaked with the electrolyte solution 106, or the electrolyte solution 106 is placed in the cell between the current collector 102 and the cathode 108, or both. After the current collector 102, separator 110 soaked with the solution, and cathode 108 have been stacked, the enclosed cell 300 may be closed or substantially closed to form a closed or substantially closed volume around the stack.

An oxidizing gas is then introduced into enclosed cell 300 to fabricate battery 100. In some examples, introducing the oxidizing gas to enclosed cell 300 includes introducing the oxidizing gas to the enclosed cell 300 via the inlet tube 302. In some examples, the enclosed cell 300 may include or be in the presence of an inert gas, such as argon, prior to introducing the oxidizing gas to the enclosed cell 300. In some such examples, introduction of the oxidizing gas may purge and completely replace the inert gas within the enclosed cell 300 with the oxidizing gas. For example, the oxidizing gas may be introduced to the enclosed cell 300 via the inlet tube 302 and the inert gas may be purged through the outlet tube 304. In some examples, the concentration of the oxidizing gas in the enclosed cell 300 may be between about 5 wt% and about 100 wt %, about 20 wt% and about 100 wt%, about 50 wt % and about 100 wt %, or about 80 wt % and about 100 wt % of the total amount of gases within the enclosed cell 300 (e.g., compared to the total amount of the oxidizing gas and the inert gas within enclosed cell 300).

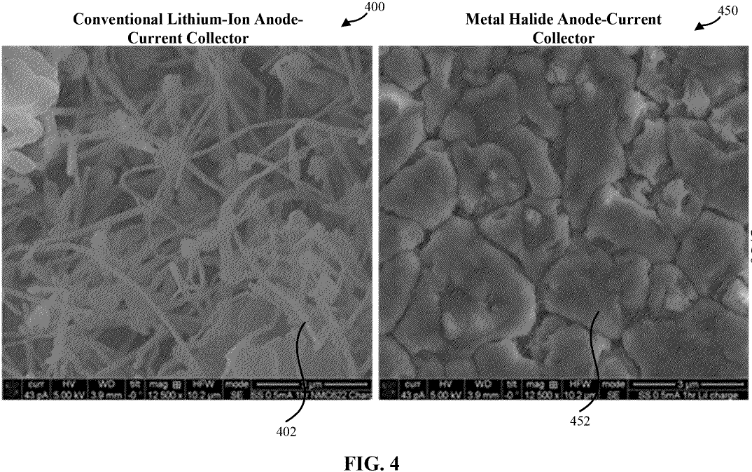

The present disclosure will now be described with respect to some non-limiting examples with reference to FIGS. 4-10. In particular, FIGS. 4-10, which show images and resulting data collected from a number of examples researched by the inventors of the present disclosure, will first be described, and then the experimental details that resulted in the data shown in FIGS. 4-10 will be discussed. However, it is to be understood in advance that these examples are only illustrative examples, and they are not meant to be limiting. As would be recognized by a person of ordinary skill in the art, numerous modifications may be made to the specific examples without departing from the spirit and scope of the invention, and such modifications are contemplated by this disclosure. For example, alternative materials, compositions of the materials, and arrangements of the material not otherwise inconsistent with this disclosure are contemplated.

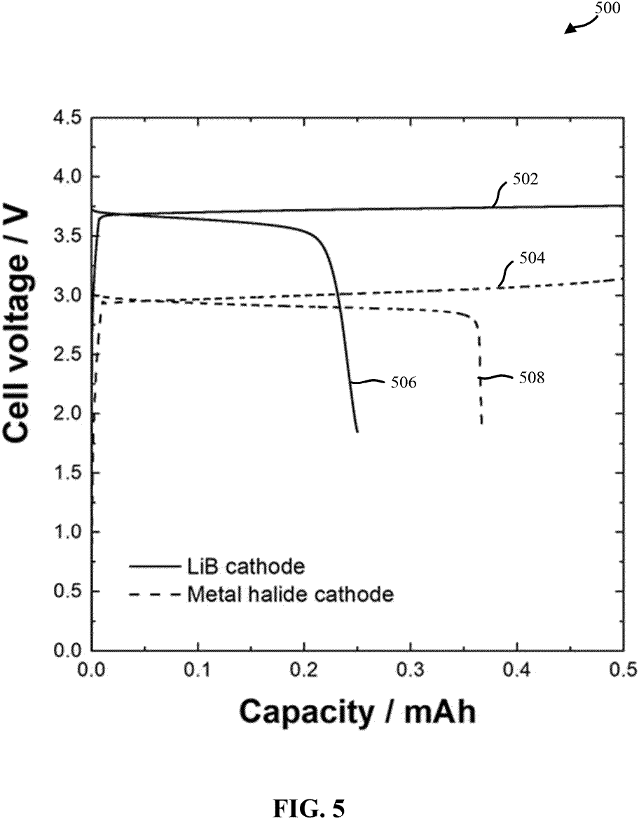

In particular, FIGS. 4 and 5 compare two different anode-free batteries: one with a conventional lithium-ion cathode and the other with a metal halide cathode constructed in accordance with embodiments of the present disclosure. Referring now to FIG. 4, depicted are scanning electron microscope (SEM) images 400, 450 of the lithium-deposited current collectors obtained from the anode-free battery cell with the conventional lithium-ion cathode (400) and with the metal halide cathode constructed in accordance with embodiments of the present disclosure (450). In particular, the SEM images 400, 450 show the lithium plating behaviors, which have a very strong effect on the electrochemical performance, such as rate performance and long-term cycle life, of lithium batteries. In FIG. 4, a stainless steel (SS) current collector was used for both the anode-free lithium-ion battery and the anode-free metal halide battery because the commonly used aluminum and copper current collectors tend to become corroded in the halide ion containing electrolyte.

As shown in FIG. 4, the Li plating behavior varies largely between the two battery chemistries. In particular, the lithium plating with the metal halide cathode is more even and better for stripping and plating during cycles because it has relatively uniform current distribution. This is illustrated by the large grain-like deposits of lithium 452 shown in the second SEM image 450 in FIG. 4. In contrast, the SEM image 400 of the lithium-deposits created by the lithium-ion cathode cell shows needle-like lithium dendrites 402. These dendrites 402 tend to form dead lithium pieces during cycles, which can significantly reduce overall capacity of the cell. The sharp dendrites also cause a short circuit of the battery, resulting in cell failure. Accordingly, FIG. 4 illustrates that the metal halide battery chemistry results in more uniform lithium plating onto the stainless steel current collector.

As discussed, the lithium morphology affects the cycle efficiency of the battery. Resulting initial charge and discharge curves for the anode-free batteries of FIG. 4 are shown in FIG. 5. In particular, FIG. 5 is a graph 500 showing initial charge 502, 504 and discharge 506, 508 curves for an anode free lithium-ion battery (502, 506) and an anode-free metal halide battery (504, 508) constructed in accordance with embodiments of the present disclosure with under 0.5 mAh capacity cut-off.

As illustrated in the graph 500, under its operating voltage, the anode-free lithium-ion battery has 49% coulombic efficiency (C.E.). In contrast, the anode-free metal halide battery shows 73% coulombic efficiency, which means that the uniform lithium plating is closely related to the higher lithium stripping in the battery. In other words, the discharge curve 506 for the lithium-ion battery falls off (indicating a fast dropping voltage) at around 0.25 mAh of capacity, which is approximately 49% of the 0.5 mAh capacity that the battery was charged to, as shown by the charge curve 502. In contrast, the discharge curve 508 of the SS-metal halide cathode battery shows that the voltage drop-off point is around 0.365 mAh, or approximately 73% of the 0.5 mAh capacity that the battery was charged to, as shown by the charge curve 504. It also shows that the anode-free metal halide battery has more promising results compared to the anode-free lithium-ion battery cell, which is likely a result of the stable, uniform SEI layer formed on the current collector.

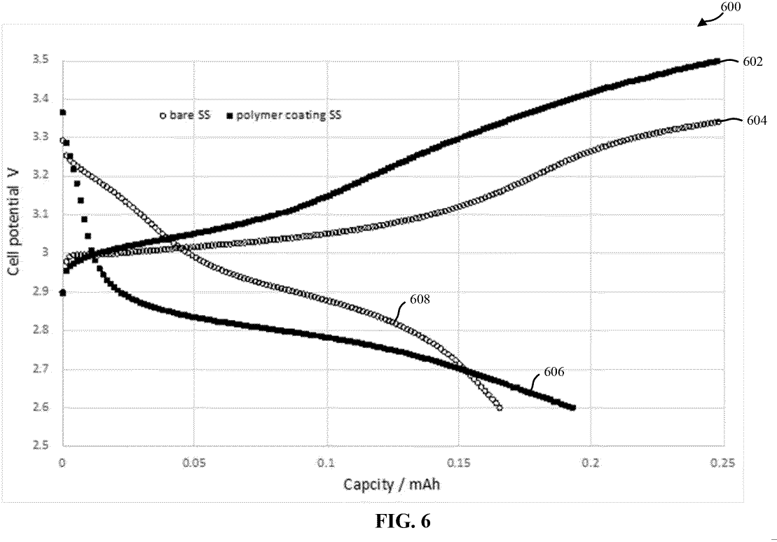

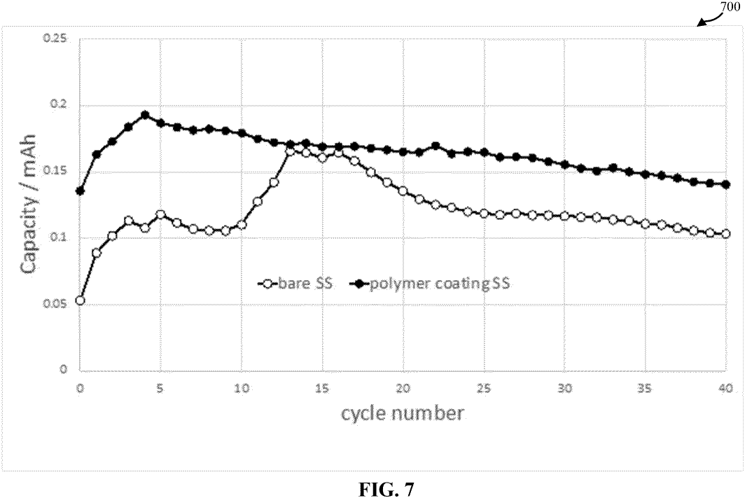

FIGS. 6 and 7 compare properties of an anode-free metal halide battery that includes a bare-metal, stainless steel current collector to an anode-free metal halide battery that has an artificial SEI (polymer-based protective coating) on top of the stainless steel current collector. A UV-crosslinked polyethyleneglycol reinforced by polyhedral oligomeric silsesquioxane (POSS-PEG) was used as the artificial SEI layer. As shown in FIG. 5, the anode-free metal halide battery is properly charging and discharging with relatively high coulombic efficiency. With the morphological benefits of the lithium plating from metal halide cathode identified, the addition of an artificial protection layer onto the current collector can help to prohibit the active material loss for SEI formation and generate higher capacity and cycle life. For this reason, the lithium ion conducting polymer coating is applied to the current collector, and it is used, in conjunction with the current collector and lithium deposits, as the anode for the battery. In some embodiments, the polymer coating thickness is roughly 20 µm, and the coating layer is polymerized by UV light.

The charge and discharge curves after aging cycles from the anode-free metal halide battery with stainless steel (SS) current collector are shown in FIG. 6. In particular, FIG. 6 is a graph 600 showing the charge 602, 604 and discharge 606, 608 curves for a metal halide battery that uses a bare metal (in this case, stainless steel) current collector (604, 608) and for a metal halide battery that includes a polymer coating on top of the stainless steel current collector (602, 606). Under the capacity cut-off, the polymer coated SS cell shows higher discharge capacity and coulombic efficiency (as illustrated by its discharge curve 606) compared to the bare SS cell (as illustrated by its discharge curve 608).

Additionally, FIG. 6 shows that in terms of overpotential during the charge and discharge reaction, the charge overpotential of the polymer coated SS cell is higher than the charge overpotential of the bare SS cell due to the thick polymer coating. This is illustrated by the charge curve 602 of the polymer coated SS cell being above the charge curve 604 of the bare-metal SS cell. Likewise, the discharge overpotential of polymer coated SS cell is higher, and this indicates that the lithium ion conducting polymer coating has resistances for the lithium-ion stripping from the anode. The resistance induced by the ion-conducting polymer coating may be reduced by increasing ionic conductivity and/or reducing the thickness of the polymer coating.

Referring now to FIG. 7, illustrated is a graph 700 showing cycle performance data for the two different anode-free metal halide battery cells, in accordance with embodiments of the present disclosure. As can be seen in the graph 700, the polymer coated SS cell has higher capacity and stable cyclability after initial stabilization cycles. In contrast, the bare SS cell has slightly unstable cycle life during 40 cycles. This illustrates that the artificial polymer coating is increasing the consistency of the charge capacity in the anode-free metal halide battery across repeated cycles.

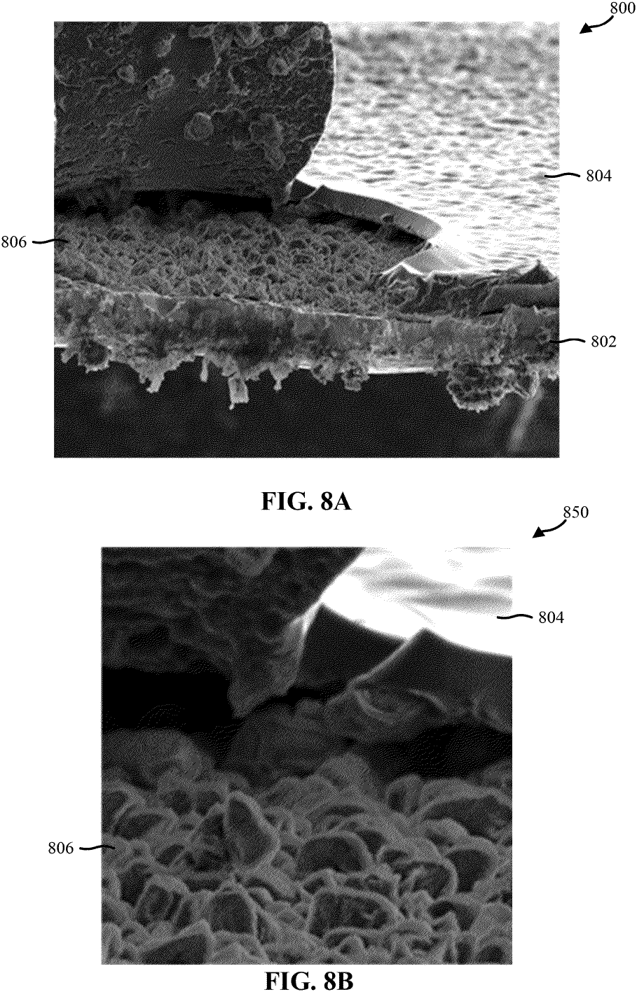

FIGS. 8A and 8B depict SEM images 800, 850 of a polymer-coated, current collector obtained from the anode-free metal halide battery cell after lithium deposition by initial charging, in accordance with embodiments of the present disclosure. In particular, FIG. 8B shows a zoomed in portion 850 of the SEM image 800 of FIG. 8A. FIGS. 8A and 8B were generated using a capacity cut-off of 0.1 mAh for the battery cell.

FIGS. 8A and 8B show a stainless steel current collector 802 on which a polymer 804 was deposited. During the initial charging operation, lithium ions permeated the polymer 804 and were deposited as lithium metal 806 on the current collector 802. The lithium metal 806 is substantially uniformly deposited underneath the polymer 804 and on top of the current collector 802. This illustrates that the polymer layer is a lithium ion conductor and that the charge reaction happens properly underneath this artificial polymer SEI layer. The magnified image in FIG. 8B further shows the round-shaped lithium deposits 806, as opposed to the needle-like dendrite that is formed on anode-free lithium-ion battery cells, uniformly placed on the current collector. Accordingly, it is possible to operate the lithium anode-free metal halide battery reversibly.

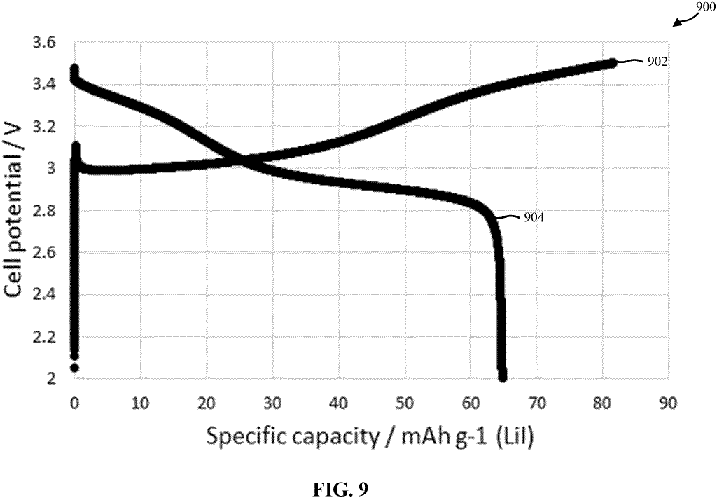

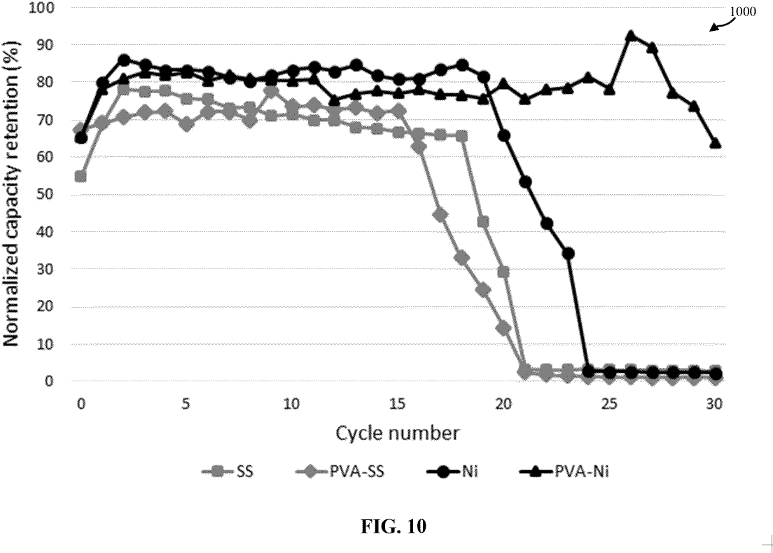

FIGS. 9 and 10 show electrochemical properties of anode-free lithium-iodide cells assembled with different metal current collectors and artificial SEI layers (e.g., bare-metal or polymer-coated). For these experiments, anode-free lithium iodide battery cells were assembled in the dry air atmosphere, the Ni foil and SS foil were used as an anode current collector, and a polyvinyl alcohol (PVA) coating was applied onto the current collector as the artificial SEI layer.

Referring first to FIG. 9, illustrated is a graph 900 showing charge 902 and discharge 904 curves for an anode-free, lithium iodide battery cell assembled with a PVA-coated Ni substrate, in accordance with embodiments of the present disclosure. The charge-discharge performance was evaluated under the voltage cut-off condition from 2.0 V to 3.5 V. It shows higher coulombic efficiency (C.E.) over 80% and good charge and discharge behavior without any voltage spikes.

Additionally, this result illustrates that the anode-free metal halide batteries disclosed herein can operate under dry air atmosphere, similarly to the cell operated under pure oxygen atmosphere as shown in FIG. 6. Notably, when the battery cell is tested under oxygen atmosphere, the oxygen reduction reaction can occur around 2.5 V, so the lower voltage was limited by the 2.6 V cut-off in FIG. 6. However, if the same battery cell is tested under dry air, the battery cell voltage can be expanded to 2.0 V (FIG. 9), which allows for higher battery cell capacity.

Referring now to FIG. 10, illustrated is a graph 1000 showing cycle performance data for four different anode-free lithium iodide battery cells assembled with bare SS (grey squares) and bare Ni (black circles) current collectors, as well as using PVA-coated SS (grey diamonds) and PVA-coated Ni (black triangles) current collectors, in accordance with embodiments of the present disclosure. The cycle performance data was acquired at 0.3 C under dry air atmosphere. As shown in the graph 1000, the cells having Ni current collector have higher capacity retention throughout the cycling compared to the ones with SS current collector. Also, in terms of cycle numbers, the cells with SS current collector have a shorter cycle life than the cells with Ni current collector. In the case of Ni substrate, applying PVA coating on the substrate improves the cycle stability up to 30 cycles under dry air atmosphere. As shown, using Ni foil as a current collector and PVA coating as an artificial SEI layer further improves the electrochemical performance of the anode-free metal halide cell.

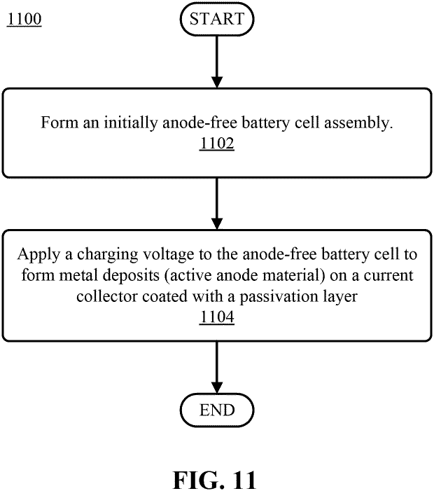

Referring now to FIG. 11, illustrated is a flowchart of an example method 1100 for forming an anode-free metal halide battery cell, in accordance with embodiments of the present disclosure. The method 1100 may be performed by hardware, firmware, software executing on a processor, or any combination thereof. For example, the method 1100 may be performed by a computer system (e.g., having a processor and memory) that is configured to control robotic and/or other devices in order to assemble batteries. The method 1100 may begin at operation 1102, where an anode-free battery cell assembly is formed.

As disclosed herein, the anode-free battery cell assembly comprises a cathode, a separator, an electrolyte, and a current collector for one or both electrodes. The anode-free metal halide battery demonstrated in this disclosure does not include a lithium anode in the initial cell, but an anode current collector only. Instead, the cathode may be composed of a lithium-containing active cathode material deposited on to a porous cathode (e.g., a carbon cathode, such as a LiI-carbon composite cathode). In some embodiments, a passivation layer, also known as solid-state electrolyte interphase layer, is formed on top of the current collector in the negative electrode. In other embodiments, a polymer coating (artificial SEI) is deposited on top of the current collector in the negative electrode.

In some embodiments, the porous carbon cathode includes an activated carbon (hosting material), super-P (electron conducting agent), and styrene butadiene rubber/carboxymethyl cellulose (SBR/CMC) binders, which were prepared by coating a slurry of carbons/binder mixture in an alcohol with 85/15 weight ratio on a stainless steel current collector. The active cathode material, LiI in methanol, is separately formulated and dosed onto the carbon cathode to form the LiI-carbon composite cathode. The LiI-carbon composite cathode was then dried on the 120° C. hotplate for approximately 12 hours, and all dosing and drying processes were conducted in an Ar-filled glove box.

In some embodiments, the electrolyte is a mixture of approximately 0.2 M LiNO₃ and approximately 0.5 M LiTFSI (Lithium bis(trifluoromethanesulfonyl)imide) in dioxolane (DOL), with 1,2-dimethoxyethane (DME) also being included. The separator may be, for example, a Celgard 2325 separator, and it may be placed between the cathode and the current collector.

To form the anode-free battery cell assembly, the current collector and the optional separator with the cathode formed thereon may be stacked together. In some embodiments, the optional separator is soaked with the electrolyte solution, or the electrolyte solution is placed in the cell between the current collector and the cathode, or both. After the current collector, separator soaked with the solution, and cathode have been stacked, the battery cell may be closed or substantially closed to form a closed or substantially closed volume around the stack.

An oxidizing gas may then be introduced into the enclosed cell to fabricate battery 100. In some examples, introducing the oxidizing gas to the enclosed cell includes introducing the oxidizing gas to the enclosed cell via an inlet tube. In some examples, the enclosed cell may include or be in the presence of an inert gas, such as argon, prior to introducing the oxidizing gas to the enclosed cell. In some such examples, introduction of the oxidizing gas may purge and completely replace the inert gas within the enclosed cell with the oxidizing gas. For example, the oxidizing gas may be introduced to the enclosed cell via the inlet tube and the inert gas may be purged through an outlet tube. In some examples, the concentration of the oxidizing gas in the enclosed cell 300 may be between about 5 wt% and about 100 wt%, about 20 wt% and about 100 wt%, about 50 wt% and about 100 wt%, or about 80 wt% and about 100 wt% of the total amount of gases within the enclosed cell.

After forming the anode-free battery cell assembly, a charging voltage may be applied to the cell assembly at operation 1104. The application of the charging voltage causes the lithium ions, which may initially have been in the cathode, the electrolyte, or both, to move towards the current collector and deposited on top of the current collector as metallic lithium that will act as the anode. In embodiments that include a naturally formed, passivation layer (SEI layer) on the bare metal current collector, the lithium ions may pass through the passivation layer and deposit on top of the bare metal current collector forming a metallic lithium layer acting as the anode for the resulting battery. In embodiments that have a polymer-coated current collector, the polymer coating may act as an artificial SEI. In these embodiments, the lithium ions may permeate the polymer coating and deposit on top of the current collector, forming a metallic lithium layer. As a result of the lithium depositing on the current collector, the current collector, along with the lithium deposits and the polymer coating, may essentially convert into, and act as, an anode for the battery. After the initial charging voltage is applied for sufficient time to enable migration of the lithium ions to the current collector, the method 1100 may end.

Some example embodiments of anode-free, metal halide batteries will now be discussed in detail. These example embodiments are non-limiting examples which the inventors have successfully made and tested using the methods disclosed herein.

Example 1: Anode-free Metal Halide Battery Assembled with LiI-Carbon Composite Cathode and Stainless Steel (SS) current collector operated under oxygen and dry air.

According to the general procedure of anode-free metal halide cells discussed above, the cells were assembled in an Ar-filled glove box or dry air-filled glove box. For SEM analysis, SS-LiI/C composite cells were assembled in a Swagelok cell in an Ar-filled glove box, and the oxygen gas was flown into the assembled cells for 30 seconds. The cells then started to operate under oxygen atmosphere after closing the inlet/outlet valves. After the 1st charging up to 1 mAh, the cell was disassembled and the SS current collector was carefully rinsed with DOL/DME solvent mixture followed by vacuum drying at room temperature. As shown in FIG. 4 (on the right), smooth and uniform lithium deposition was observed on the SS current collector. Also, the SS-LiI/C composite cell was operated at a capacity of 0.5 mAh under oxygen atmosphere, and the charge-discharge curves showed much better Coulombic efficiency (73% in FIG. 5-dotted plot) compared to the identical cell assembled with an NMC cathode (discussed as the Comparative Example 1 below).

A coin-type cell was also assembled in a dry air-filled glove box. For this, the electrolyte was the mixture of 0.2 M LiNO₃, 0.2 M LiBOB and 0.5 M LiTFSI in DOL/DME. This experiment had a voltage cut-off condition from 2.0 to 3.5 V at 0.3 C, and the cyclability of the cell is plotted in FIG. 7 (SS).

Example 2: Anode-free Metal Halide Battery Assembled with LiI-Carbon Composite Cathode and Ni current collector operated under dry air.

The same cell components and assembly method as described in the general procedure were applied except that the current collector was Ni instead of SS. With a Ni current collector, the coin-type cell was assembled with an electrolyte having 0.2 M LiNO₃, 0.2 M LiBOB(Lithium bis(oxalate)borate) and 0.5 M LiTFSI in DOL/DME solution. The installed cell was operated under a voltage cut-off condition from 2.0 to 3.5 V at 0.3 C. The charge and discharge curves and cyclability are plotted in FIG. 9 and FIG. 10 (Ni), respectively.

Example 3: Anode-free Metal Halide Battery Assembled with LiI-Carbon Composite Cathode and SS current collector coated with PEG-POSS operated under oxygen.

A cell was assembled by following the general method described above. As an artificial protection layer, a crosslinked PEG-POSS (PEG: PEG-methyl ether acrylate, POSS: Methacryl polyhedral oligomeric silsesquioxane) film was applied onto the SS metal current collector. The crosslinked coating process was conducted in the Ar-filled glove box. The PEG was freeze-dried under vacuum for 2 days, and then it was stored on molecular sieves. The PEG, POSS, and a photo initiator (Darocur 1173) were all mixed together based on the weight ratio of 10:1 as PEG:POSS and 0.1 wt.% UV initiator of the total solution. The resulting solution was stirred for 10 min before the solution was applied to the current collector by doctor blade coating, and the coating layer was polymerized by UV light exposure for up to 2 minutes.

For the electrochemical test and SEM analysis, as this experiment was conducted under oxygen atmosphere, the Swagelok cell was assembled, and the oxygen gas was purged for 30 seconds. The initial cycle (FIG. 6) and the long-term cycle (FIG. 7) tests were conducted under 0.5 mA current for 30 min, with a 0.25 mAh capacity cut-off. In order to observe the lithium deposits onto the current collector, the cell with a PEG/POSS coated stainless steel current collector was assembled, and it was charged to the capacity of 0.1 mAh. After the cell disassembly, the POSS-PEG coated current collector was carefully rinsed with DOL/DME solvent mixture and then dried under vacuum at room temperature. Cross sectional SEM images of the POSS-PEG coated current collector are shown in FIGS. 8A and 8B. The lithium deposited underneath the POSS-PEG artificial SEI layer and directly on the SS current collector.

Example 4: Anode-free Metal Halide Battery Assembled with LiI-Carbon Composite Cathode and SS current collector coated with PVA operated under dry air.

An anode-free metal halide battery with LiI/C composite cathode and SS current collector was prepared using the general procedure discussed above. An artificial SEI layer of polyvinyl alcohol (PVA) polymer was applied on to a SS current collector. For this test, 5 wt.% of PVA in de-ionized water solution was applied to the SS current collector by a doctor blade method. After drying at 60° C. oven for 12 hours, the polymer-coated SS was used as a current collector. The assembled coin cell with an electrolyte having 0.2 M LiNO₃, 0.2 M LiBOB and 0.5 M LiTFSI in DOL/DME solvent was operated at 0.3 C under dry air atmosphere, and the resulting cycle life is plotted in FIG. 10.

Example 5: Anode-free Metal Halide Battery Assembled with LiI-Carbon Composite Cathode and Ni current collector coated with PVA operated under dry air.

An anode-free metal halide battery with a LiI/C composite cathode and Ni current collector was prepared by the general procedure discussed above. To create an artificial SEI layer, PVA polymer coating was applied to a Ni current collector. A coin cell with an electrolyte having 0.2 M LiNO₃, 0.2 M LiBOB and 0.5 M LiTFSI in DOL/DME solvent was assembled in a dry air-filled glove box, and it was operated at 0.3 C under a voltage cut-off condition from 2.0 to 3.5 V. The resulting cycle life is plotted in FIG. 10.

Comparative Example 1: Anode-free Lithium-Ion Battery Assembled with NMC622 Cathode operated under oxygen.

For comparison, a conventional Li(Ni0.6Mn0.2Co0.2)O2 (NMC622) cathode, and the 1 M LiPF6 in EC/DEC (ethylene carbonate/diethyl carbonate) electrolyte, Celgard 2325 separator, and SS current collector were obtained. The SS-NMC cell was assembled in a configuration of Swagelok cell at the Ar-filled glove box. Before the charge/discharge test, oxygen gas was flown into the assembled cells for 30 seconds, and the cell started to operate under oxygen atmosphere after closing the inlet/outlet valves. This cell was charged to the capacity of 1 mAh in order to deposit lithium on the SS current collector, and the surface morphology of the deposited lithium was observed by scanning electron microscope (SEM) after rinsing the SS substrate with DMC solvent followed by vacuum drying at room temperature for 1 hour. As shown in FIG. 4 (on the left), sharp, needle-like structures had formed by lithium deposition (lithium dendrite growth), which eventually results in a short-circuit within the battery. The cell operated at 0.5 mA for 1 hour shows a poor coulombic efficiency (49%), as shown in FIG. 5 (solid line).

The terminology used herein is for the purpose of describing particular embodiments only and is not intended to be limiting of the various embodiments. As used herein, the singular forms “a,” “an,” and “the” are intended to include the plural forms as well, unless the context clearly indicates otherwise. It will be further understood that the terms “includes” and/or “including,” when used in this specification, specify the presence of the stated features, integers, steps, operations, elements, and/or components, but do not preclude the presence or addition of one or more other features, integers, steps, operations, elements, components, and/or groups thereof. In the previous detailed description of example embodiments of the various embodiments, reference was made to the accompanying drawings (where like numbers represent like elements), which form a part hereof, and in which is shown by way of illustration specific example embodiments in which the various embodiments may be practiced. These embodiments were described in sufficient detail to enable those skilled in the art to practice the embodiments, but other embodiments may be used and logical, mechanical, electrical, and other changes may be made without departing from the scope of the various embodiments. In the previous description, numerous specific details were set forth to provide a thorough understanding the various embodiments. But, the various embodiments may be practiced without these specific details. In other instances, well-known circuits, structures, and techniques have not been shown in detail in order not to obscure embodiments.

As used herein, “a number of” when used with reference to items, means one or more items. For example, “a number of different types of networks” is one or more different types of networks.

When different reference numbers comprise a common number followed by differing letters (e.g., 100a, 100b, 100c) or punctuation followed by differing numbers (e.g., 100-1, 100-2, or 100.1, 100.2), use of the reference character only without the letter or following numbers (e.g., 100) may refer to the group of elements as a whole, any subset of the group, or an example specimen of the group.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combinations of these items can be present. In some illustrative examples, “at least one of” can be, for example, without limitation, two of item A; one of item B; and ten of item C; four of item B and seven of item C; or other suitable combinations.

In the foregoing, reference is made to various embodiments. It should be understood, however, that this disclosure is not limited to the specifically described embodiments. Instead, any combination of the described features and elements, whether related to different embodiments or not, is contemplated to implement and practice this disclosure. Many modifications, alterations, and variations may be apparent to those of ordinary skill in the art without departing from the scope and spirit of the described embodiments. Furthermore, although embodiments of this disclosure may achieve advantages over other possible solutions or over the prior art, whether or not a particular advantage is achieved by a given embodiment is not limiting of this disclosure. Thus, the described aspects, features, embodiments, and advantages are merely illustrative and are not considered elements or limitations of the appended claims except where explicitly recited in a claim(s). Additionally, it is intended that the following claim(s) be interpreted as covering all such alterations and modifications as fall within the true spirit and scope of the invention.

A non-limiting list of Example Embodiments are provided hereinafter to demonstrate some aspects of the present disclosure.

Example Embodiment 1 is an anode-free metal halide battery. The anode-free metal halide battery includes a negative current collector comprising a passivation layer of an electrically insulating material that allows metal ion transport, an electrolyte comprising an ion-conducting material, and a cathode comprising a metal halide salt incorporated into an electrically conductive material, wherein the electrolyte is in contact with the negative current collector and the cathode.

Example Embodiment 2 includes the anode-free metal halide battery of Example Embodiment 1, including or excluding optional features. In this Example Embodiment, the anode-free metal halide battery includes an oxidizing gas.

Example Embodiment 3 includes the anode-free metal halide battery of any one of Example Embodiments 1 to 2, including or excluding optional features. In this Example Embodiment, the passivation layer is created naturally on the negative current collector in contact with the electrolyte.

Example Embodiment 4 includes the anode-free metal halide battery of any one of Example Embodiments 1 to 3, including or excluding optional features. In this Example Embodiment, the electrically conductive material is a porous carbon material, forming a metal halide-carbon composite cathode.

Example Embodiment 5 includes the anode-free metal halide battery of any one of Example Embodiments 1 to 4, including or excluding optional features. In this Example Embodiment, the electrolyte is selected from the group consisting of a liquid electrolyte, a gel polymer electrolyte, a solid-polymer electrolyte, a ceramic-based electrolyte, a polymer-ceramic composite electrolyte, and a combination thereof.

Example Embodiment 6 includes the anode-free metal halide battery of any one of Example Embodiments 1 to 5, including or excluding optional features. In this Example Embodiment, the passivation layer includes an artificially formed ion-conducting material. Optionally, the ion-conducting material is chosen from the group consisting of a linear polymer, a crosslinked polymer, a star polymer, a block copolymer, metal oxides and combinations thereof. Optionally, the ion-conducting material further comprises an inorganic filler chosen from the group consisting of carbon nanotubes, nanoparticles, polyhedral oligomeric silsesquioxane (POSS) compounds, and combinations thereof.

Example Embodiment 7 includes the anode-free metal halide battery of any one of Example Embodiments 1 to 6, including or excluding optional features. In this Example Embodiment, the anode-free metal halide battery includes an electrically non-conductive separator between the negative current collector and the cathode.

Example Embodiment 8 includes the anode-free metal halide battery of any one of Example Embodiments 1 to 7, including or excluding optional features. In this Example Embodiment, the thickness of the passivation layer is in the range of 0.1 nanometers to 20 micrometers.

Example Embodiment 9 includes the anode-free metal halide battery of any one of Example Embodiments 1 to 8, including or excluding optional features. In this Example Embodiment, the thickness of the passivation layer is between 0.1 nanometers and 1 micrometer.

Example Embodiment 10 includes the anode-free metal halide battery of any one of Example Embodiments 1 to 9, including or excluding optional features. In this Example Embodiment, the negative current collector acts as an anode upon deposition of metal thereon.

Example Embodiment 11 includes the anode-free metal halide battery of any one of Example Embodiments 1 to 10, including or excluding optional features. In this Example Embodiment, the negative current collector is a metal foil located at the negative terminal of the battery.

Example Embodiment 12 includes the anode-free metal halide battery of any one of Example Embodiments 1 to 11, including or excluding optional features. In this Example Embodiment, the anode-free metal halide battery includes a positive current collector.

Example Embodiment 13 is an anode-free metal halide battery. The anode-free metal halide battery includes a negative current collector, an electrolyte comprising a solvent and at least one ion conducting salt; and a cathode comprising a metal halide compound deposited on a conductive carbon material, wherein the electrolyte is in contact with the negative current collector and the cathode.

Example Embodiment 14 includes the anode-free metal halide battery of Example Embodiment 13, including or excluding optional features. In this Example Embodiment, the cathode comprises lithium ions deposited on a porous carbon material. Optionally, the porous carbon material is a LiI-carbon composite.

Example Embodiment 15 includes the anode-free metal halide battery of any one of Example Embodiments 13 to 14, including or excluding optional features. In this Example Embodiment, the passivation layer includes an artificially formed ion-conducting material. Optionally, the ion-conducting material is selected from the group consisting of polyvinyl alcohol (PVA) and poly(ethylene glycol) (PEG) copolymerized with polyhedral oligomeric silsesquioxane (POSS).

Example Embodiment 16 includes the anode-free metal halide battery of any one of Example Embodiments 13 to 15, including or excluding optional features. In this Example Embodiment, the anode-free metal halide battery includes a separator between the negative current collector and the cathode.

Example Embodiment 17 includes the anode-free metal halide battery of any one of Example Embodiments 13 to 16, including or excluding optional features. In this Example Embodiment, the thickness of the passivation layer is in the range of 0.1 nanometers to 20 micrometers.

Example Embodiment 18 is a method for forming an anode-free metal halide battery. The method includes forming a metal halide battery cell, wherein the metal halide battery cell includes a negative current collector and does not include a discrete anode. The method further includes applying a charging voltage to the metal halide battery cell to cause metal ions to be reduced to corresponding metal on the negative current collector.

Example Embodiment 19 includes the method of Example Embodiment 18, including or excluding optional features. In this Example Embodiment, the metal halide battery cell further includes a passivation layer on top of the negative current collector, an electrolyte comprising a solvent and at least one ion conducting salt, and a cathode comprising a metal halide compound deposited on an electrically conductive material, wherein the electrolyte is in contact with the negative current collector and the cathode. Optionally, the passivation layer comprises an artificially formed ion-conducting material selected from the group consisting of polyvinyl alcohol (PVA) and poly(ethylene glycol) (PEG) copolymerized with polyhedral oligomeric silsesquioxane (POSS). Optionally, the cathode comprises lithium iodides deposited on a porous carbon material, and wherein applying the charging voltage to the battery cell causes lithium ions released from the cathode to be reduced to lithium metal on the negative current collector.

What is claimed is:

1. An anode-free metal halide battery, comprising:
a negative current collector comprising a passivation layer of an electrically insulating material that allows metal ion transport;
an electrolyte comprising an ion-conducting material; and
a cathode comprising a metal halide salt incorporated into an electrically conductive material, wherein the electrolyte is in contact with the negative current collector and the cathode.

2. The battery of claim 1, further comprising an oxidizing gas.

3. The battery of claim 1, wherein the passivation layer is created naturally on the negative current collector in contact with the electrolyte.

4. The battery of claim 1, wherein the electrically conductive material is a porous carbon material, forming a metal halide-carbon composite cathode.

5. The battery of claim 1, wherein the electrolyte is selected from the group consisting of a liquid electrolyte, a gel polymer electrolyte, a solid-polymer electrolyte, a ceramic-based electrolyte, a polymer-ceramic composite electrolyte, and a combination thereof.

6. The battery of claim 1, wherein the passivation layer includes an artificially formed ion-conducting material.

7. The battery of claim 6, wherein the ion-conducting material is chosen from the group consisting of a linear polymer, a crosslinked polymer, a star polymer, a block copolymer, metal oxides and combinations thereof.

8. The battery of claim 6, wherein the ion-conducting material further comprises an inorganic filler chosen from the group consisting of carbon nanotubes, nanoparticles, polyhedral oligomeric silsesquioxane (POSS) compounds, and combinations thereof.

9. The battery of claim 1, further comprising:
an electrically non-conductive separator between the negative current collector and the cathode.

10. The battery of claim 1, wherein the thickness of the passivation layer is in the range of 0.1 nanometers to 20 micrometers.

11. The battery of claim 1, wherein the thickness of the passivation layer is between 0.1 nanometers and 1 micrometer.

12. The battery of claim 1, wherein the negative current collector acts as an anode upon deposition of metal thereon.

13. The battery of claim 1, wherein the negative current collector is a metal foil located at the negative terminal of the battery.

14. The battery of claim 1, further comprising a positive current collector.

15. An anode-free metal halide battery, comprising:
a negative current collector;
an electrolyte comprising a solvent and at least one ion conducting salt; and
a cathode comprising a metal halide compound deposited on a conductive carbon material, wherein the electrolyte is in contact with the negative current collector and the cathode.

16. The battery of claim 15, wherein the cathode comprises lithium ions deposited on a porous carbon material.

17. The battery of claim 16, wherein the porous carbon material is a LiI-carbon composite.

18. The battery of claim 15, wherein the passivation layer includes an artificially formed ion-conducting material.

19. The battery of claim 18, wherein the ion-conducting material is selected from the group consisting of:
polyvinyl alcohol (PVA);
poly(ethylene glycol) (PEG) copolymerized with polyhedral oligomeric silsesquioxane (POSS);
poly(ethylene glycol);
poly(propylene glycol);
polycarbonates;
polyesters;
polyethylene oxide (PEO);
polyurethane (PU);
styrene-butadiene rubber (SBR);
polyvinylidene difluoride (PVDF); and
poly(tetrafluoroethylene) (PTFE).

20. The battery of claim 15, further comprising:
a separator between the negative current collector and the cathode.

21. The battery of claim 15, wherein the thickness of the passivation layer is in the range of 0.1 nm to 20 µm.

22. A method for forming an anode-free metal halide battery, the method comprising:
forming a metal halide battery cell, wherein the metal halide battery cell includes a negative current collector and does not include a discrete anode; and
applying a charging voltage to the metal halide battery cell to cause metal ions to be reduced to corresponding metal on the negative current collector.

23. The method of claim 22, wherein the metal halide battery cell further includes:
a passivation layer on top of the negative current collector;
an electrolyte comprising a solvent and at least one ion conducting salt; and
a cathode comprising a metal halide compound deposited on an electrically conductive material, wherein the electrolyte is in contact with the negative current collector and the cathode.

24. The method of claim 23, wherein the passivation layer comprises an artificially formed ion-conducting material selected from the group consisting of:
polyvinyl alcohol (PVA);
poly(ethylene glycol) (PEG) copolymerized with polyhedral oligomeric silsesquioxane (POSS);
poly(ethylene glycol);
poly(propylene glycol);
polycarbonates;
polyesters;
polyethylene oxide (PEO);
polyurethane (PU);
styrene-butadiene rubber (SBR);
polyvinylidene difluoride (PVDF); and
poly(tetrafluoroethylene) (PTFE).

25. The method of claim 23, wherein the cathode comprises lithium iodides deposited on a porous carbon material, and wherein applying the charging voltage to the battery cell causes lithium ions released from the cathode to be reduced to lithium metal on the negative current collector.
